(19) United States
(12) Patent Application Publication
(10) Pub. No.: US 2026/0223945 A1
(43) Pub. Date: Aug. 6, 2026

(54) User Authentication System, Dongle, And Method

(71) Applicant: JT International SA, Geneva (CH)

(72) Inventor: Franck Pourrat, Les Gras (FR)

(73) Assignee: JT International SA, Geneva (CH)

(21) Appl. No.: 19/146,362

(22) PCT Filed: Jan. 11, 2024
(86) PCT No.: PCT/EP2024/050625

§ 371 Date: Jul. 8, 2025

(30) Foreign Application Priority Data
Jan. 13, 2023 (EP) 2315620.4

(51) Int. Cl. A24F 40/49; A24F 40/53; A24F 40/90; G06F 21/34

(52) U.S. Cl. CPC A24F 40/49; A24F 40/53; A24F 40/90; G06F 21/34

(57) ABSTRACT

A user authentication system for an aerosol generating device includes: an aerosol generating device; a dongle configured to interact with the aerosol generating device, the dongle including a processor configured to: perform a user authentication process; and upon authenticating a user by the user authentication process, change an operating state of the aerosol generating device, wherein the processor is configured to change the operating state of the aerosol generating device to allow the aerosol generating device to be provided with electrical power from a power source for charging the aerosol generating device.

The present disclosure relates to a user authentication system, in particular a user authentication system for an aerosol generating device. The present disclosure also relates to a dongle, in particular a dongle configured to interact with an aerosol generating device. The present disclosure also relates to a method.

### BACKGROUND

An aerosol generating device operates to generate aerosol for inhalation by a user. It is desirable to authenticate a user of the aerosol generating device. Hardware may be incorporated in an aerosol generating device to enable user authentication to be performed at the aerosol generating device. This results in an aerosol generating device of complex construction. Furthermore, retrofit of such hardware for user authentication is not practical with commercially available aerosol generating devices.

It is the object of the invention to overcome at least some of the above referenced problems, or problems discussed elsewhere.

### SUMMARY

According to the present disclosure there is provided a user authentication system, dongle, and method, including the features as set out in the claims.

According to a first aspect of the present invention, there is provided a user authentication system for an aerosol generating device comprising: an aerosol generating device; a dongle configured to interact with the aerosol generating device, the dongle comprising a processor configured to: perform a user authentication process; and upon authenticating a user by the user authentication process, change an operating state of the aerosol generating device.

In this way, the aerosol generating device and/or another associated device (such as a charging device, for example a portable charger, or the like) need not incorporate hardware for performing user authentication. Instead, a dongle can be used to authenticate the user of the aerosol generating device. The dongle is a separate piece of hardware. The dongle may be configured (e.g., specifically configured) to perform the user authentication, and may incorporate hardware for performing the user authentication process. That is, the dongle may be configured to provide the aerosol generating device with additional functionality. Advantageously, in this way, hardware for the purpose of user authentication need not be incorporated in the aerosol generating device, either during initial manufacture or retrofit. Space saving benefits are thus also obtained in the aerosol generating device. Minimising the size of the aerosol generating device (e.g., “miniaturization”) is highly advantageous in product design and is facilitated by the user authentication hardware being provided at the dongle. Flexibilities are thereby provided to end users and manufacturers. Furthermore, advantageously, the dongle is a lightweight and portable piece of hardware.

A dongle might typically be additionally or alternatively defined or described as a small (e.g. smaller than the aerosol generating device) piece of hardware that connects (physically or wirelessly, but typically physically) to a port or other connector on another device (e.g. the aerosol generating device) to provide it with additional or alternative functionality, or enable a pass-through to such a device that adds functionality.

The dongle may be arranged to interact with the aerosol generating device without insertion into the aerosol generating device. That is, the dongle is not a “receiving device”, such as a base or mount (such as a base, mount or dock with charging functionality), or the like.

The processor is configured to change the operating state of the aerosol generating device to allow the aerosol generating device to be provided with electrical power from a power source for charging the aerosol generating device.

In this way, following user authentication, the aerosol generating device may be controlled to allow charging of the aerosol generating device. This is highly advantageous as changing the operating state in said manner prevents or inhibits unauthorised use of the aerosol generating device. In particular, changing the operating state in said manner prevents or inhibits unauthorised use of the aerosol generating device for an extended period of time, by virtue of the need to perform a user authentication process to charge the aerosol generating device. Furthermore, and highly advantageously, the facilitation of change in operating state to allow provision of electrical power is by the dongle—i.e., a separate piece of hardware, as described above. This is highly advantageous as such functionality need not be provided by the aerosol generating device itself (and thus appropriate hardware need not be incorporated therein). The size or profile of the aerosol generating device can thereby be reduced, providing flexibilities to end users and manufacturers. Furthermore, such functionality need not be provided by the power source, which reduces complexity of the user authentication system.

The change in operating state may be a change from a non-power provision state (i.e., a non-charging state) to a power provision state (i.e., a charging state). Additionally, or alternatively, the change in operating state may be a change in an authentication flag at the aerosol generating device. That is, the operating state may be a “locked” or “unlocked” state. In a locked state provision of power to the aerosol generating device may be prevented, whereas in an unlocked state provision of power to the aerosol generating device may be allowed.

In one example, the processor is configured to change the operating state of the aerosol generating device to allow the aerosol generating device to be provided with electrical power via the dongle.

In this way, the dongle may act as a “smart switch”, controlling the provision of electrical power from the power source to the aerosol generating device. Furthermore, in this way, the power source need not be incorporated in the dongle. As a result, complexity of the system is reduced, and the size of the dongle may be reduced ensuring portability.

The dongle may comprise electrical circuitry for enabling the provision of electrical power from the power source to the aerosol generating device via the dongle. The dongle may comprise a USB-C (or other form of USB) receptacle, for receiving power input from a USB-C power source. The dongle may comprise a USB-C (or other form of USB) connector, for providing electrical power connection with the aerosol generating device. The connection between the power source and the dongle and/or between the dongle and the aerosol generating device may be a wired connection. Advantageously, a wired connection is cheap to manufacture and is robust. Alternatively, the dongle may comprise wireless power transfer functionality, between the power source and the dongle and/or between the dongle and the aerosol generating device.

In one example, the processor is configured to change the operating state of the aerosol generating device by providing an authentication signal to the aerosol generating device upon authenticating the user.

In this way, the authentication signal allows the aerosol generating device to determine that the user is an authenticated user. The authentication signal is an output from the dongle. The authentication signal may be an output of the user authentication process.

In one example, the aerosol generating device is configured to receive the authentication signal and set an authentication flag at the aerosol generating device.

In this way, the setting of the authentication flag may correspond with, or be, the change in operating state of the aerosol generating device. Advantageously, by using authentication flags, an authenticated state may be maintained for a period of time whilst the authentication flag is set in an authenticated state. Furthermore, setting the authentication flag may comprise changing the authentication flag from a non-authenticated state to an authenticated state. Such a change may be referred to as “resetting” the authentication flag.

In one example, the operating state of the aerosol generating device controls a level of aerosol generation by the aerosol generating device.

In this way, the aerosol generating device may be operated at a reduced, or restricted, level of aerosol generation where the user is not authenticated. Subsequently, if a user is authenticated, the aerosol generating device may be operated at an increased, or unrestricted, level of aerosol generation. That is, when the user is authenticated, the user may be free to select the desired level of aerosol generation, which may be a higher level than that possible when the user is not authenticated (e.g., a non-authenticated user, or prior to authentication of the user).

### In one example, the dongle is connectable to an external power source

That is, the dongle itself is not a power source. Rather, power is providable from the external power source to the aerosol generating device via the dongle. In this way, the dongle is simpler and cheaper to manufacture, and is more robust.

In one example, the dongle is connectable between the external power source and the aerosol generating device.

In this way, power from the external power source may be provided through the dongle from the external power source to the aerosol generating device. Such a construction is in contrast to one in which the external power source is provided in a receiving device, which is configured to receive or couple to the aerosol generating device, which results in a more complex and expensive construction. The present system is cheaper and simpler to manufacture, as the dongle is provided as a separate hardware element connectable between the external power source and the aerosol generating device.

In one example, the aerosol generating device comprises a controller configured to request authentication of the user.

In this way, the aerosol generating device drives the request for user authentication upon its own request scheme. When authentication of the user is requested, the aerosol generating device may operate in a corresponding mode, such as a reduced power mode or reduced aerosol generation mode, until the user is authenticated.

In one example, the controller is configured to request authentication of the user: at random; before or after an aerosol inhalation session; after a pre-determined time period; and/or after a pre-determined time period following last use of the aerosol generating device.

In this way, the aerosol generating device drives the request for user authentication upon its own request scheme.

Advantageously, by requesting authentication of the user at random, use by non-authenticated users can be prevented, as it will not be possible to predict when the aerosol generating device will request authentication.

Advantageously, by requesting authentication of the user before an aerosol inhalation session, the user may use the aerosol generating device but will understand that authentication may be required for future use of the device. Furthermore, requesting authentication before an aerosol inhalation session may prevent use of the device by an unauthorised user unless the user can be authenticated.

Advantageously, by requesting authentication of the user after an aerosol inhalation session, user experience is not negatively impacted. An aerosol inhalation session may be a period of time in which the user uses the aerosol inhalation session, e.g., takes a series of puffs, to consume aerosol by inhalation.

Advantageously, by requesting authentication of the user after a pre-determined time period, the user may understand the need for regular authentication in order to change the operating state of the device, such as enabling charging of the device. Furthermore, in this way, it may regularly be ensured that the user of the device is an authorised user.

Advantageously, by requesting authentication of the user after a pre-determined time period following last use of the aerosol generating device, it can be ensured that the subsequent use of the device is by an authenticated user. This may be particularly advantageous in a situation where a user ceases to use the device for a period of time, and a new, unauthorised, user attempts to use the aerosol generating device. User authentication may then be required in order to change the operating state, for example facilitate charging of the aerosol generating device.

In one example, the aerosol generating device is configured to removably house the dongle.

In this way, the dongle may be removably located within, or partially or fully housed by, the aerosol generating device. This is highly advantageous in storage and transport of the dongle. Furthermore, the small form factor of the dongle may facilitate such a construction. The dongle and/or receiving portion of the aerosol generating device in which the dongle is housed may be shaped such that the aerosol generating device has a continuous outer profile when the dongle is received therein. That is, the dongle may be housed within the aerosol generating device such that a surface of the dongle is continuous with an outer surface of the aerosol generating device. Such a construction may improve user experience, storage and transport of the dongle, as well as mitigating damage to the dongle.

In one example, the user authentication system comprises a plurality of aerosol generating devices, wherein the dongle is configured to interact with the plurality of aerosol generating devices.

In this way, a single dongle may be used to authenticate a user (e.g., of a plurality of devices) and an operating state of all of the devices may be changed. The dongle may be used with a plurality of the same model of device, or a plurality of different device models. Advantageously, a plurality of aerosol generating devices may be charged via the same dongle.

In one example, the user authentication process comprises fingerprint authentication, vein pattern detection, gesture detection, motion detection and/or a password entry.

In this way, the user authentication process is robust and secure. However, advantageously, necessary hardware for the user authentication process need not be incorporated in the aerosol generating device, but instead may be provided in the dongle. Thus, complexity and cost of the system can be reduced.

According to a second aspect of the present invention, there is provided a dongle configured to interact with an aerosol generating device, the dongle comprising a processor configured to: perform a user authentication process; upon authenticating a user by the user authentication process, change an operating state of the aerosol generating device.

The dongle of the second aspect may incorporate any or all of the features of the first aspect, as desired or as appropriate. Indeed, advantages of the second aspect will be apparent from the advantages of the first aspect, described above. Specific to the second aspect, providing a dongle for interaction with an aerosol generating device may enable a user authentication system to be formed, for authenticating a user of the aerosol generating device. Indeed, in this way, the user authentication system can be provided in a retrofit manner, for example to provide additional or alternative functionality to an existing an aerosol generating device.

According to a third aspect of the present invention, there is provided a method of authenticating a user of an aerosol generating device, comprising: providing a dongle interacting with the aerosol generating device; performing a user authentication process at the dongle; upon authenticating a user by the user authentication process, changing an operating state of the aerosol generating device.

The method may comprise performing the user authentication process at the dongle prior to (i.e., before) providing the dongle interacting with the aerosol generating device. Advantageously, this may simplify the user authentication process for the user. Alternatively, the method may comprise performing the user authentication process at the dongle subsequent to (i.e., after) providing the dongle interacting with the aerosol generating device. Advantageously, this may increase security or ensure validity of the user authentication process, as it is ensured that the authenticated user is present when the dongle is provided to interact with the aerosol generating device.

The method of the third aspect may incorporate any or all of the features of the first or second aspect, as desired or as appropriate. Indeed, advantages of the third aspect will be apparent from the advantages of the first and second aspect, described above.

### BRIEF DESCRIPTION OF THE DRAWINGS

Examples of the present disclosure will now be described with reference to the accompanying drawings, in which:

FIG. 1 shows a user authentication system;

FIG. 2 shows an aerosol generating device;

FIG. 3 shows a dongle;

FIG. 4 shows a process;

FIG. 5 shows a dongle; and

FIG. 6 shows general methodology principles.

### DETAILED DESCRIPTION

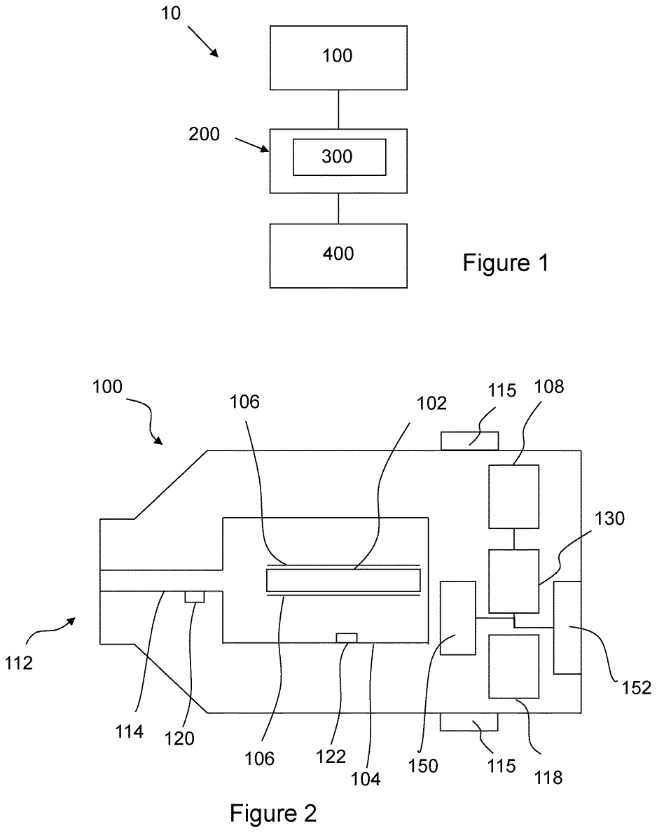

FIG. 1 shows a system 10, specifically a user authentication system 10. The user authentication system 10 is for an aerosol generating device. That is, the user authentication system 10 may be for authenticating a user of an aerosol generating device. The system 10 comprises an aerosol generating device 100 and a dongle 200.

The aerosol generating device 100 may otherwise be referred to as a “vaping device”or “nicotine delivery device”.

The dongle 200 is configured to interact with the aerosol generating device 100. As described above, the dongle 200 is a separate piece of hardware. The dongle 200 may be configured (e.g., specifically configured) to perform the user authentication, and may incorporate hardware for performing the user authentication process. That is, the dongle 200 may be configured to provide the aerosol generating device with additional functionality. Interaction between the dongle 200 and the aerosol generating device 100 may be a communicative interaction and/or a physical connection between the dongle 200 and aerosol generating device 100. That is, the interaction may facilitate a change in an authentication flag at the aerosol generating device and/or allow power supply via the dongle 200. The dongle 200 comprises a processor 300.

The processor 300 is configured to perform a user authentication process. The processor 300 is configured to change an operating state of the aerosol generating device upon authenticating a user by the user authentication process. The processor 300 may be a microprocessor or microcontroller. Processing by the processor 300 may interact with (e.g. provide inputs to, or receive inputs from) a controller or processor of the aerosol generating device 100 (such as controller 130 discussed below).

As described in greater detail herein, operation of the user authentication system 10 includes user authentication being performed at the dongle 200 and the changing of an authentication flag at the aerosol generating device 100. In this way, for a time period, the operating state of the aerosol generating device 100 may be changed to, for example, enable charging of the aerosol generating device 100 without use of the dongle 200. In another example of operation of the user authentication system, user authentication may be performed at the dongle 200 and power supplied to the aerosol generating device 100 through, or via, the dongle 200 (e.g. from a power source 400, which may be referred to as a power supply). In this way, no authentication flag (or corresponding firmware) need be required by the aerosol generating device 100. These examples may be combined in that authentication flags could be used alongside the requirement for power to be supplied to the aerosol generating device 100 through, or via, the dongle 200.

In overview of an exemplary operation of the system 10, the dongle 200 may be necessarily required in order to change an operating state of the aerosol generating device 100 by successful user authentication. If the user is authenticated by the user authentication process, the aerosol generating device 100 may be charged and/or used to generate aerosol. However, if the user is not authenticated (for example by unsuccessful user authentication process, or due to failure to connect the dongle 200) then the aerosol generating device 100 may not be provided with charging power even when connected to an external power source. Once the user is successfully authenticated by the user authentication process, charging of the aerosol generating device 100 can be enabled or allowed.

FIG. 2 shows a schematic cross-sectional view of an aerosol generating device. The aerosol generating device 100 is suitable for receiving a consumable 102 therein. For example, the aerosol generating device 100 may include a chamber 104 in which the consumable 102 is received.

The invention is not limited to the specific aerosol generating device 100 or consumable 102 described herein. That is, the description of the aerosol generating device 100 and consumable 102 is provided for illustrative purposes only. The skilled person will appreciate that alternative constructions of aerosol generating devices and consumables will be compatible with the present invention.

A consumable 102 comprises an aerosol substrate. The term aerosol substrate is a label used to mean a medium that generates an aerosol or vapour when heated. Aerosol substrate might be interpreted as an aerosol precursor. In one example, aerosol substrate is synonymous with smokable material, aerosol generating substrate and aerosol generating medium. Aerosol substrate includes materials that provide volatilized components upon heating, typically in the form of vapor or an aerosol. Aerosol substrate may be a non-tobacco-containing material or a tobacco-containing material. Aerosol substrate may, for example, include one or more of tobacco per se, tobacco derivatives, expanded tobacco, reconstituted tobacco, tobacco extract, homogenized tobacco or tobacco substitutes. Aerosol substrate also may include other, non-tobacco, products, which, depending on the product, may or may not contain nicotine. Aerosol substrate may comprise one or more humectants, such as glycerol or propylene glycol.

The aerosol generating device 100 may comprise one or more heaters 106 configured to provide heat to the consumable 102, in use.

In one example, the consumable 102 contains a liquid and the one or more heaters comprises a heating element, such as a coil, a ceramic heater, a flat resistive heater, a mesh heater, a MEMS heater, or the like, configured to aerosolise the liquid for inhalation. A liquid delivery element or mechanism, such as a porous material, a capillary system, and/or valve, may transfer the liquid to the heating element, in use. In some examples, the aerosolised liquid may pass through a solid substrate within the aerosol generating device 100. In other examples, the consumable 102 may comprise a solid aerosol substrate.

In one example, the aerosol generating device 100 comprises a nebulizing engine, such as a vibrating mesh, to generate an aerosol from a liquid with or without heating thereof.

The aerosol generating device 100 may comprise a mouthpiece 112 through which a user draws on the aerosol generating device 100 to inhale generated aerosol. The mouthpiece 112 includes a vent or channel 114 that is connected to a region close to the consumable 102 for passage of any generated aerosol from the consumable 102, during use. For example, the channel 114 may extend between an opening in the mouthpiece 112 and the chamber 104 in which the consumable 102 is at least partially receivable. The mouthpiece 112 is arranged such it may be received in a user's mouth in use. In other examples, a mouthpiece 112 is not required and a portion of the consumable 102 may protrude from the aerosol generating device 100. In this example, protruded portion of the consumable 102 may work as mouthpiece.

The aerosol generating device 100 may comprise a control unit 108 (or control circuitry) for electronic management of the device. The control unit 108 may include a PCB or the like (not shown). The control unit 108 is configured to control the one or more heaters 106.

The aerosol generating device 100 may comprise an activation input sensor 118. The activation input sensor 118 may be a button, a touchpad, or the like for sensing a user's input, such as a tap or swipe. In other examples, the activation input sensor 118 comprises a consumable sensor configured to detect if a consumable 102 has been inserted into the aerosol generating device 100. For example, the input sensor 118 may comprise an authenticity detector that is configured to detect if an authentic consumable 102 has been inserted into the aerosol generating device 100. Additionally, or alternatively, the user input may also comprise an inhalation action by a user.

The aerosol generating device 100 may comprise a puff sensor 120 (otherwise known as an inhalation sensor). The puff sensor 120 is configured to detect an inhalation action (or puff) by a user on the aerosol generating device 100. In one example, the puff sensor 120 comprises a microphone or a flow sensor configured to an airflow within the chamber 104 and/or an airflow channel extending from the chamber 104 through the mouthpiece 112 to an inhalation outlet thereof, the airflow being associated with a user's inhalation action. In other examples, the puff sensor 120 is configured to detect a change in pressure indicative of a beginning of an inhalation action on the aerosol generating device by the user. In this case, the puff sensor 120 may be located anywhere on the aerosol device 100 in which there would be a change in pressure due to an inhalation action of the user. In one example, the puff sensor 120 is located in the channel 114 between the chamber 104 and the mouthpiece 112 of the aerosol generating device 100. The puff sensor 120 may also detect the end of an inhalation action by the user. For example, the puff sensor 120 may be configured to detect a further change in pressure due to the end of an inhalation action of a user.

The aerosol generating device 100 may include one or more temperature sensors 122 configured to directly or indirectly measure the temperature of the consumable 102 in the aerosol generating device 100. The one or more temperature sensors 122 may comprise a temperature sensor, such as a thermocouple or thermistor, configured to be located within or adjacent to the consumable 102 when it is received in the aerosol generating device 100. For example, the one or more temperature sensors 122 may be located within the chamber 104 of the aerosol generating device 100. In other examples, the temperature of the consumable 102 may be indirectly measured by the use of thermal imaging sensors. In further other example, the heater 106 itself works as a temperature sensor if the heater 105 has PTC (Positive Temperature Coefficient) or NTC (Negative Temperature Coefficient) characteristic.

The aerosol generating device 100 may include a power supply 150 such as a battery. The power supply may provide the aerosol generating device 100 with electrical energy providing a voltage in the range of 3 V and 4.2 V. In a preferred embodiment the voltage source is a lithium-ion secondary battery delivering a value of 3.7 V. Such a voltage source is particularly advantageous for a modern aerosol generating device in view of rechargeability, high energy density and large capacity. The power supply 150 may provide power for operation of the aerosol generating device 100, for example the necessary power to generate aerosol. In an example, the power supply 150 may provide power to one or more heaters 106.

The aerosol generating device 100 may comprise a controller 130. The controller 130 is connected to the control unit 108. The controller 130 is configured to receive data from the control unit 108. In particular, the controller 130 is configured to receive data from the control unit 108 relating to various sensors/inputs (such as the activation input sensor 118, puff sensor 120 and/or temperature sensor 122) of the aerosol generating device 100.

The controller 130 and the control unit 108 may be integral with each other. In one example, a single component performs the function of the control unit 108 and controller 130. In other examples, the control unit 108 and the controller 130 are distinct components.

The aerosol generating device 100 may comprise a USB port 152 (e.g., a USB receiving port). The USB port may provide connection to the controller 130.

Referring back to FIG. 1, in one example, the processor 300 is configured to change the operating state of the aerosol generating device 100 to allow the aerosol generating device 100 to be provided with electrical power from a power source 400 for charging the aerosol generating device 100.

That is, in an example, the change in operating state of the aerosol generating device 100 may be a change from a non-charging state to a charging state. Such states may be states which allow or prevent charging of the aerosol generating device 100 (e.g., charging of the battery 150 of the aerosol generating device 100), or may be states of the aerosol generating device 100 in which charging is provided or not provided.

As described in further detail elsewhere herein, the operating state may be a “locked” or “unlocked” state based on an authentication flag. In such cases, there may be no charging (e.g., charging prevented) in the locked state, whilst there may be charging (e.g., charging allowed) in the unlocked state.

In one example, the processor 300 is configured to change the operating state of the aerosol generating device 100 to allow the aerosol generating device 100 to be provided with electrical power via the dongle 200.

That is, upon or following authentication of the user by the user authentication process, electrical power is providable to the aerosol generating device 100 via, or through, the dongle 200. In this way, the dongle 200 acts as a smart switch between the power source 400 and the aerosol generating device 100, where power is provided through the dongle 200.

In one example, the processor 300 is configured to change the operating state of the aerosol generating device 100 by providing an authentication signal to the aerosol generating device 100 upon authenticating the user.

The dongle 200 is thereby operable to initiate a change in an operating state of the aerosol generating device 100 by providing the aerosol generating device 100 with the authentication signal. In this way, the operating state can only be changed when the authentication signal is provided upon authenticating the user. It is thus possible to ensure that the aerosol generating device 100 is only usable (e.g., chargeable) by an authorised or authenticated user.

In one example, the aerosol generating device 100 is configured to receive the authentication signal and set an authentication flag at the aerosol generating device 100.

As mentioned above, the aerosol generating device 100 comprises a controller 130. The controller 130 may be configured to receive the authentication signal. The controller 130 may also be configured to set the authentication flag upon receipt of the authentication signal.

The controller 130 of the aerosol generating device 100 and processor 300 of the dongle may be dedicated components. The controller 130 and processor 300 may be distinct components, configured to interact and/or communicate with one another.

As described above, use of authentication flags is advantageous in that an authenticated state can be maintained for a period of time whilst the authentication flag is set in an authenticated state. On receipt of the authentication signal, the aerosol generating device 100 may set the authentication flag in an authenticated state. This may comprise changing the authentication flag from a non-authenticated state to an authenticated state. This may be known as “resetting” the authentication flag.

It may be necessary to reset the authentication flag at different times, depending on the configuration of the aerosol generating device 100 and manufacturer or user settings. This will be described in greater detail below.

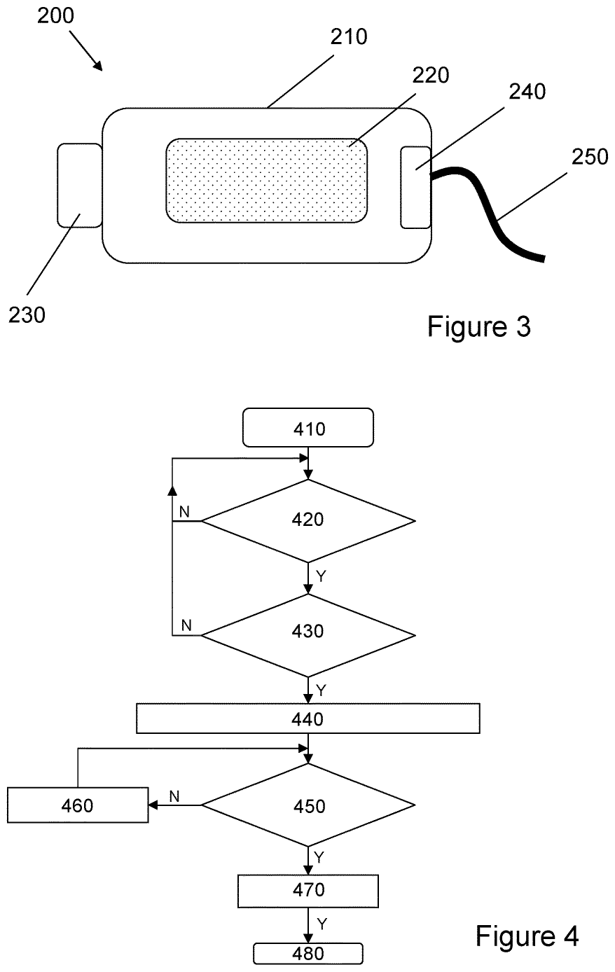

Referring to FIG. 3, an Exemplary Arrangement of the Dongle 200 Is Shown.

The dongle 200 comprises a housing 210. Provided on the housing 210 is a user authentication module 220. The user authentication module 220 is for use in the user authentication process. The user authentication module 220 may be configured to perform fingerprint authentication, vein pattern detection and/or enable a password entry.

The dongle 200 comprises a first universal serial bus (USB) port 230. The first USB port 230 is a connector, for connection to a power source (such as a portable charger, mains supply, or charging port on a PC or the like) or power adapter (which in turn may be connected to a mains supply).

The dongle 200 comprises a second USB port 240. The second USB port 240 is a receptacle, for receiving a USB cable. The second USB port 240 may be connectable to the aerosol generating device 100 by a USB cable (indicated in-part at 250). Electrical power for charging the aerosol generating device 100 (e.g., the battery 150 of the aerosol generating device 100) may thus be provided from a power source 400 to the aerosol generating device 100 via the dongle 200. The second USB port 240 of the dongle 200 may be connected with, or connectable with, the USB port 152 of the aerosol generating device 100 using a USB cable.

The USB connection may conform to the USB-C standard.

Referring to FIG. 4, an exemplary process comprising the user authentication process is shown.

At Step 410, the system 10 is provided.

At Step 420, it is determined whether the aerosol generating device 100 requires charging. In some examples, the charge level of the aerosol generating device 100 is established. Below a threshold charge level of a battery 150 of the aerosol generating device 100, it may be indicated that the aerosol generating device 100 requires charging. In other examples, it may always be established that the aerosol generating device 100 is to be charged, irrespective of aerosol generating device 100 charge/battery level.

If charging is not required, the user may continue to use the aerosol generating device 100 as normal. However, in some examples, despite charging not being required, if user authentication is required then the aerosol generating device 100 may request user authentication and prevent or limit normal operation or some functionality of the aerosol generating device. For example, a relatively reduced level of aerosol generation may be caused until user authentication is performed. In this case, the process may proceed to Step 430.

If charging is required, the process proceeds to Step 430

At Step 430, it is determined whether user authentication is required. In one example, user authentication may be required every time charging is to be performed. In another example, user authentication may be required when the aerosol generating device 100 requires, or requests, authentication of the user.

If user authentication is not required, the aerosol generating device 100 may allow normal operation of the aerosol generating device 100 until charging is required, or until user authentication is required. The process then returns to Step 420.

If user authentication is required, the process proceeds to Step 440.

At Step 440, the dongle 200 is required to perform user authentication. The dongle 200 is provided (e.g., connected) between the power source 400 and the aerosol generating device 100. This connection may be performed by virtue of the first and second USB ports 230, 240 described above. When the connection is made, the controller 300 of the dongle 200 may enable the user authentication module 220. The user authentication module 220 may then be used to authenticate the user, for example by scanning user biometrics.

Step 440 incorporates the user authentication process. The user authentication process is performed, to authenticate the user of the aerosol generating device. In an example, the dongle 200 is used to perform an authentication of the user, which may include a biometric identification of the user. This may be by virtue of fingerprint identification or vein pattern detection at the user authentication module 220 of the dongle 200.

At Step 450, it is established whether the user authentication process was successful. Successful authentication of the user may include establishing that the user is an authorised user of the aerosol generating device 100, such as an owner (e.g., registered owner) of the aerosol generating device 100. Additionally, or alternatively, successful authentication of the user may include establishing that the user meets one or more requirements (e.g., an age limit of the locality or territory in which the aerosol generating device 100 is located) to use the aerosol generating device 100.

If it is established that the user authentication process was not successful, the process proceeds to Step 460.

At Step 460, the provision of charging power from the power source 400 to the aerosol generating device 100 (in particular, to the battery 150 of the aerosol generating device 100) is prevented or disabled. The provision of power may be prevented or disabled until successful user authentication occurs.

If it is established that the user authentication process was successful, the process proceeds to Step 470.

At Step 470, the provision of charging power from the power source 400 to the aerosol generating device 100 is allowed or enabled (in particular, to the battery 150 of the aerosol generating device 100). This may be achieved by closing of a load switch in the dongle 200. This may be in response to the provision of an authentication signal from the processor 300 of the dongle 200 to the aerosol generating device 100, and the reception of said authentication signal at the aerosol generating device 100. Power can then be drawn from the second USB port 240 (i.e., the downstream port). In this way, power can only be drawn by the aerosol generating device 100 if or when the user authentication process is successful. The provision of power may be allowed or enabled until the battery 150 of the aerosol generating device 100 is fully charged, until the aerosol generating device 100 is disconnected from the dongle 200, and/or until the dongle 200 is disconnected from the power source 400.

The process ends at Step 480.

In one example, the operating state of the aerosol generating device 100 controls a level of aerosol generation by the aerosol generating device 100.

In this way, usage of the aerosol generating device 100 may be reduced, or restricted, until a user is authenticated and the operating state of the aerosol generating device 100 is changed accordingly.

In one example, the dongle 200 is connectable to an external power source 400.

As described above, the dongle 200 may be connectable to the external power source 400 by a USB (e.g., USB-C) cable. Additionally, or alternatively, the dongle may be wirelessly connectable to the external power source 400. In all cases, power may be provided from the external power source 400 to, or through, the dongle 200 via the connection.

In examples, the external power source 400 may be a portable charger, mains supply, or charging port on a PC, laptop, vehicle, or the like, or power adapter (which in turn may be connected to a mains supply). Advantageously, in this way, the dongle 200 need not comprise a battery or power supply. Power may be provided to the aerosol generating device 100 via, or through, the dongle 200. Furthermore, any power required by the dongle 200 may be obtained from the external power source 400.

In one example, the dongle 200 is connectable between the external power source 400 and the aerosol generating device 100.

That is, the dongle 200 may be separate to the external power source 400 and the aerosol generating device 100 in an in-use configuration. The dongle 200 may be a distinct component. In this way, the componentry and functionality of the dongle 200 need not be incorporated in either the external power source 400 or in the aerosol generating device 100. This simplifies manufacture of such components and reduces costs.

The dongle 200 may be connectable between the external power source 400 and aerosol generating device 100 using cables, or by a wireless connection.

In one example, the aerosol generating device 100 comprises a controller configured to request authentication of the user. That is, the controller 130 may be configured to request authentication of the user. This is relevant to Step 430 described above. In this instance, the aerosol generating device 100 itself drives the request for authentication of the user.

The controller 130 may be referred to as a microcontroller or microprocessor.

The request for authentication of the user may cause a change in an authentication flag of the aerosol generating device 100. For example, the controller 500 may request authentication of the user and simultaneously change the authentication flag from an unlocked, or authenticated, state to a locked, or unauthenticated, state. Use of the aerosol generating device 100, including charging and/or aerosol generation, may thereby be prevented or restricted.

In a highly advantageous example, following the request for authentication of the user, the aerosol generating device 100 must be connected to the dongle 200 and the user authentication process successfully carried out before charging of the aerosol generating device 100 is enabled. Subsequently, charging may take place via the dongle 200, or by direct connection to the external power source 400.

The controller 500 is configured to request authentication of the user: at random; before or after an aerosol inhalation session; after a pre-determined time period; and/or after a pre-determined time period following last use of the aerosol generating device 100.

Related advantages are discussed in detail above.

The start or end of an aerosol inhalation session may be established by the control unit 108, activation input sensor 118, puff sensor 120, temperature sensor 122, controller 130, or other components of the aerosol generating device 100.

A pre-determined time period may be after a pre-determined number of seconds, minutes, hours, days, weeks, and so on. Where the pre-determined time period is a number of seconds, it is preferable that charging of the aerosol generating device 100 is restricted until further user authentication, but not aerosol generation.

A pre-determined time period following last use of the aerosol generating device 100 may be a number of seconds, minutes, hours, days, weeks, and so on following last use, or the last aerosol inhalation session.

At each of these instances, the controller 500 may request authentication of the user and change an authentication flag in the aerosol generating device 100 thereby to prevent or restrict use, including charging and/or aerosol generation, of the aerosol generating device 100.

As described above, following the request for authentication of the user, the aerosol generating device 100 may require connection to the dongle 200 and the user authentication process successfully completed before charging of the aerosol generating device 100 is enabled. Subsequently, charging may take place via the dongle 200, or by direct connection to the external power source 400.

The aerosol generating device 100 is configured to removably house the dongle 200.

The aerosol generating device 100 may comprise a housing portion having a region, compartment, or volume for receiving the dongle 200 therein. Said region, compartment, or volume may be shaped to receive the dongle 200. That is, the dongle 200 and said region, compartment or volume of the aerosol generating device 100 may be shaped so as to be conformal. The dongle 200 may define an outer surface of the aerosol generating device 100, such as a region of a housing of the aerosol generating device 100, when the dongle 200 is received in said region, compartment or volume of the aerosol generating device 100. The dongle 200 may be housed within, or by, the aerosol generating device 100.

Such an arrangement is highly advantageous in storage and transport of the dongle 200.

The aerosol generating device 100 may removably house the dongle 200 by virtue of a clip arrangement, connector, sliding fit, or the like.

A highly advantageous use of the invention may comprise removing the dongle 200 from being housed in the aerosol generating device 100, and connecting the dongle 200 between the external power source 400 and the aerosol generating device 100 to perform the user authentication process and change an operating state of the aerosol generating device 100.

In one example, the system 10 comprises a plurality of aerosol generating devices 100. The dongle 200 is configured to interact with the plurality of aerosol generating devices 100.

The plurality of aerosol generating devices 100 may all be the same type of aerosol generating device 100, or may include different types of aerosol generating devices 100. That is, a single dongle 200 may be configured to interact with a plurality of the same aerosol generating device 100, or a mixture of different aerosol generating devices 100. The user authentication process performed by the dongle 200 can be used to change an operating state of each of the plurality of aerosol generating devices 100.

Each aerosol generating device 100 of the plurality may perform in the manner described above, and will be well understood by the skilled person from the present disclosure.

The user authentication process comprises fingerprint authentication, vein pattern detection, gesture detection, motion detection and/or a password entry.

Fingerprint authentication and vein pattern detection are examples of biometric user authentication methods. The user authentication process may comprise any other biometric user authentication method, as suitable or desirable. The user authentication module 220 may comprise a fingerprint scanner and/or vein detector.

Gesture detection and/or motion detection are another form of user authentication. Gesture detection and/or motion detection may be a type of “personal code”. In an example, the user authentication module 220 may comprise a gesture detector or motion detector. The gesture detector and/or motion detector may comprise an accelerometer and/or gyroscopic sensor. That is, the user authentication module 220 may be configured to perform gesture detection or motion detection.

In an example, the user may move the dongle 200 and/or perform a gesture with the dongle 200. That is, the user may hold the dongle 200 in their hand and move the dongle 200 and/or perform a gesture with the dongle 200. The motion or gesture performed using the dongle 200 may correspond with a predefined (e.g., prestored or pre-recorded) motion or gesture. If the motion or gesture performed using the dongle 200 corresponds with the predefined motion or gesture, the user may be established to be an authenticated user (i.e., the user authentication process is successful). The operation of the user authentication system 10 then continues as described above.

Possible gestures include a tapping gesture on the dongle 200 (e.g., a double tap, or a tap of a particular pattern), holding the dongle 200 in a particular orientation (e.g., upside down) for a period of time, rotating or spinning the dongle 200 in a particular way. It will be appreciated by those skilled in the art that other gestures are possible to be used in the user authentication process.

During a setup process, the user may perform enrolment, which may involve the performance and storage of a motion or gesture to be used in authentication. For example, the user may perform, and possibly repeat (e.g., several times), a desired motion or gesture to be used as an authentication motion or gesture. The authentication motion or gesture may be stored at the dongle 200 as the predefined motion or gesture.

The user may then perform the predefined motion or gesture using the dongle 200. The processor 300 of the dongle 200 may determine, from an input provided by the user authentication module 220, that the user is an authenticated user. An authentication signal, or authentication flag, can then be stored in the dongle 200 (e.g., at the processor 300, and/or in a memory of the dongle 200), and/or provided to the aerosol generating device 100. The authentication signal, or authentication flag, may be stored at the dongle 200 for a predetermined period of time (e.g., on the order of seconds or minutes). This is advantageous in ensuring that the user authentication process is performed by an authenticated user but the interaction, or connection, of the dongle 200 to the aerosol generating device is not performed by a non-authenticated user.

The authentication may take place prior to interaction, or connection, of the dongle 200 to the aerosol generating device 100. When the aerosol generating device 100 and dongle 200 are provided in interaction (e.g., when they are connected, for example by USB cable as described above), the authentication signal may be transmitted to the aerosol generating device 100. That is, the gesture detection and/or motion detection may be performed prior to connection of the dongle 200 and aerosol generating device 100 (i.e., when they are not provided to interact), or indeed after connection of the dongle 200 and aerosol generating device 100 (i.e., when they are provided to interact). As above, the aerosol generating device 100 (in particular the controller 130) may be configured to set the authentication flag upon receipt of the authentication signal from the dongle 200.

In an example, motion detection may involve detection of a normal walking pattern, gait, or stride length of a user. This may be used to determine that the user is an authenticated user. For example, a user of a certain height may have a known walking pattern, gait or stride length. The dongle 200 may be stored in a pocket of the user, and motion detection used to determine that the dongle 200 is in the possession of an authenticated user.

The user authentication module 200 may additionally or alternatively comprise a touchpad or keypad for password entry.

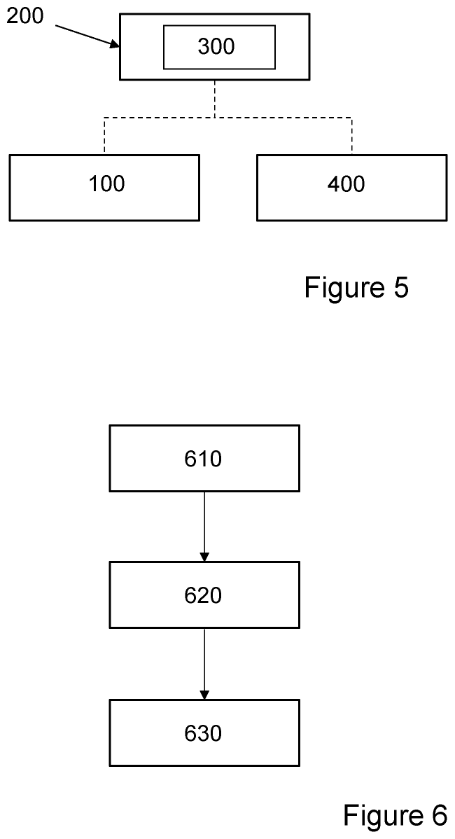

Referring to FIG. 5, the dongle 200 is shown. The dongle 200 is configured to interact with an aerosol generating device 100. The dongle 200 comprises a processor 300 configured to perform a user authentication process. The processor 300 is configured to change an operating state of the aerosol generating device 100 upon authenticating a user by the user authentication process.

The dongle 200 may comprise any of the features of system 10 described above, as desired or as appropriate.

It will be appreciated that the dongle 200 may be provided in the absence of an aerosol generating device 100 and/or a power source 400, and configured to interact with an aerosol generating device 100 and/or a power source 400. That is, the dongle may be retrofit in an existing system 10 as described above.

Referring to FIG. 6, a method of authenticating a user of an aerosol generating device 100 is shown. Step 610 comprises providing a dongle 200 interacting with the aerosol generating device 100. Step 620 comprises performing a user authentication process at the dongle 200. Step 630 comprises changing an operating state of aerosol generating device 100 upon authenticating a user by the user authentication process.

The method may include any or all features of the system 10 or dongle 200 described above, as desired or as appropriate.

The order of Step 610 and Step 620 may be reversed. That is, the user authentication process may be performed at the dongle 200, and an authentication signal or flag may be stored at the dongle 200, prior to providing the dongle 200 in interaction with the aerosol generating device 100. Subsequently, when the dongle 200 is interacting with the aerosol generating device 100 (e.g., by connection of dongle 200 and aerosol generating device 100), the authentication signal or flag may be provided from the dongle 200 to the aerosol generating device 100. This is applicable to the entire disclosure provided herein. In a particular example involving a user authentication process comprising gesture detection or motion detection, the user may perform a predefined motion or gesture using the dongle 200 prior to interaction with the aerosol generating device 100. The authentication signal or flag may be stored at the dongle for a predetermined period of time. After this time elapses, it may be necessary to repeat the user authentication process, or reperform the predefined gesture or motion. Subsequently, when the dongle 200 and aerosol generating device 100 are interacting (e.g., by connection, such as USB connection), the authentication signal or flag stored at the dongle 200 due to successful user authentication may be provided to the aerosol generating device 100. The operating state of the aerosol generating device 100 may thereby be changed. As above, in an example, charging is thereby allowed or enabled.

Although preferred embodiments have been shown and described, it will be appreciated by those skilled in the art that various changes and modifications might be made without departing from the scope of the invention. One or more of the steps described above may be optional and not performed in systems and methods without departing from the scope of the invention. The scope of the invention is as defined in the appended claims.

1. A user authentication system for an aerosol generating device comprising:
an aerosol generating device;
a dongle comprising a hardware component separate from the aerosol generating device and configured to interact with the aerosol generating device, the dongle comprising a processor configured to:
perform a user authentication process; and
upon authenticating a user by the user authentication process, change an operating state of the aerosol generating device,
wherein the processor is configured to change the operating state of the aerosol generating device by providing an authentication signal to the aerosol generating device upon authenticating the user, wherein the aerosol generating device is configured to receive the authentication signal and set an authentication flag at the aerosol generating device to allow the aerosol generating device to be provided with electrical power from a power source for charging the aerosol generating device without use of the dongle.

2. The user authentication system according to claim 1, wherein the processor is configured to change the operating state of the aerosol generating device to allow the aerosol generating device to be provided with electrical power via the dongle.

3. (canceled)

4. (canceled)

5. The user authentication system according to claim 1, wherein the operating state of the aerosol generating device controls a level of aerosol generation by the aerosol generating device.

6. The user authentication system according to claim 1, wherein the dongle is connectable to an external power source

7. The user authentication system according to claim 6, wherein the dongle is connectable between the external power source and the aerosol generating device.

8. The user authentication system according to claim 1, wherein the aerosol generating device comprises a controller.

9. The user authentication system according to claim 8, wherein the controller is configured to request authentication of the user:
at random;
before or after an aerosol inhalation session;
after a pre-determined time period;
and/or after a pre-determined time period following last use of the aerosol generating device.

10. The user authentication system according to claim 1, wherein the aerosol generating device is configured to removably house the dongle.

11. The user authentication system according to claim 1, comprising a plurality of aerosol generating devices, wherein the dongle is configured to interact with each of the plurality of aerosol generating devices.

12. The user authentication system according to claim 1, wherein the user authentication process comprises fingerprint authentication, vein pattern detection, gesture detection, motion detection and/or a password entry.

13. A dongle configured to interact with an aerosol generating device, the dongle comprising a hardware component separate from the aerosol generating device, the dongle further comprising a processor configured to:
perform a user authentication process; and
upon authenticating a user by the user authentication process, change an operating state of the aerosol generating device,
wherein the processor is configured to change the operating state of the aerosol generating device by providing an authentication signal to the aerosol generating device upon authenticating the user, wherein the authentication signal is receivable at the aerosol generating device and is used to set an authentication flag at the aerosol generating device to allow the aerosol generating device to be provided with electrical power from a power source for charging the aerosol generating device without use of the dongle.

14. A method of authenticating a user of an aerosol generating device, comprising:
providing a dongle interacting with the aerosol generating device, the dongle comprising a hardware component separate from the aerosol generating device;
performing a user authentication process at the dongle; and
upon authenticating a user by the user authentication process, changing an operating state of the aerosol generating device by the dongle providing an authentication signal to the aerosol generating device upon authenticating the user, wherein the aerosol generating device receives the authentication signal and sets an authentication flag at the aerosol generating device, to allow the aerosol generating device to be provided with electrical power from a power source for charging the aerosol generating device for charging the aerosol generating device without use of the dongle.

15. The user authentication system according to claim 8, wherein the controller is configured to receive the authentication signal; and
set the authentication flag upon receipt of the authentication signal.

16. The user authentication system according to claim 8, wherein the controller is configured to request authentication of the user.
